(19) United States
(12) Patent Application Publication
(10) Pub. No.: US 2012/0272013 A1
(43) Pub. Date: Oct. 25, 2012

(54) DATA ACCESS SYSTEM WITH AT LEAST MULTIPLE CONFIGURABLE CHIP SELECT SIGNALS TRANSMITTED TO DIFFERENT MEMORY RANKS AND RELATED DATA ACCESS METHOD THEREOF

(76) Inventor: Ming-Shi Liou, Taipei City (TW)

(21) Appl. No.: 13/092,989

(22) Filed: Apr. 25, 2011

(51) Int. Cl. G06F 12/00

(52) U.S. Cl. 711/150; 711/E12.001

(57) ABSTRACT

A data access system includes a memory controller, a first memory rank, a second memory rank, a first chip select bus coupled between the memory controller and the first memory rank, a second chip select bus coupled between the memory controller and the second memory rank, a group of shared buses shared by the first and second memory ranks and coupled between the memory controller and each of the first and second memory ranks, a first group of dedicated buses dedicated to the first memory rank and coupled between the memory controller and the first memory rank, and a second group of dedicated buses dedicated to the second memory rank and coupled between the memory controller and the second memory rank.

### BACKGROUND

The disclosed embodiments of the present invention relate to reading data from or writing data into a storage device, and more particularly, to a data access system with at least multiple configurable chip select signals transmitted to different memory ranks and related data access method thereof.

As processors are developed to have increased performance/computing power, memory access performance becomes a significant bottleneck on the overall system performance. The interface utilized to communicate data between a memory device and a memory controller may be a significant source of such a bottleneck. For example, a conventional data access system has a memory controller capable of accessing one memory channel at which a single memory device (e.g., a dynamic random access memory (DRAM) device) is disposed. Therefore, the memory controller asserts a chip select signal for selecting the single memory device to be accessed, and issues commands and memory addresses to the selected single memory device via command and address buses for reading data from the selected single memory device or writing data into the selected single memory device. The data communicated between the memory controller and the selected single memory device is transmitted via the data buses. As only one memory device is allowed to be accessed in each data access (read/write) operation, the performance of such a conventional data access system is poor, resulting in degradation of the overall system performance.

Thus, there is a need for an innovative data access system which can have improved data access efficiency to thereby improve the overall system performance.

### SUMMARY

In accordance with exemplary embodiments of the present invention, a data access system with at least multiple configurable chip select signals transmitted to different memory ranks and related data access method thereof are proposed to solve the above-mentioned problem.

According to a first aspect of the present invention, an exemplary data access system is disclosed. The exemplary data access system includes a memory controller, a plurality of memory ranks including at least a first memory rank and a second memory rank, a plurality of chip select buses including at least a first chip select bus coupled between the memory controller and the first memory rank and a second chip select bus coupled between the memory controller and the second memory rank, a group of shared buses shared by the first and second memory ranks and coupled between the memory controller and each of the first and second memory ranks, a first group of dedicated buses dedicated to the first memory rank and coupled between the memory controller and the first memory rank, and a second group of dedicated buses dedicated to the second memory rank and coupled between the memory controller and the second memory rank.

According to a second aspect of the present invention, an exemplary data access method is disclosed. The exemplary data access method includes: coupling a first chip select bus to a first memory rank, coupling a second chip select bus to a second memory rank, sharing a group of shared buses by the first and second memory ranks, utilizing a first group of dedicated buses dedicated to the first memory rank, utilizing a second group of dedicated buses dedicated to the second memory rank, accessing the first memory rank through at least the first chip select bus, the group of shared buses, and the first group of dedicated buses, and accessing the second memory rank through at least the second chip select bus, the group of shared buses, and the second group of dedicated buses.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data access system according to a first exemplary embodiment of the present invention.

FIG. 2 is a timing diagram illustrating an exemplary data access system operating under a first operational mode.

FIG. 3 is a timing diagram illustrating an exemplary data access system operating under a second operational mode.

FIG. 4 is a timing diagram illustrating an exemplary data access system operating under a third operational mode.

FIG. 5 is a timing diagram illustrating an exemplary data access system operating under a fourth operational mode.

FIG. 6 is a diagram illustrating a data access system according to a second exemplary embodiment of the present invention.

FIG. 7 is a diagram illustrating a data access system according to a third exemplary embodiment of the present invention.

FIG. 8 is a diagram illustrating a data access system according to a fourth exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

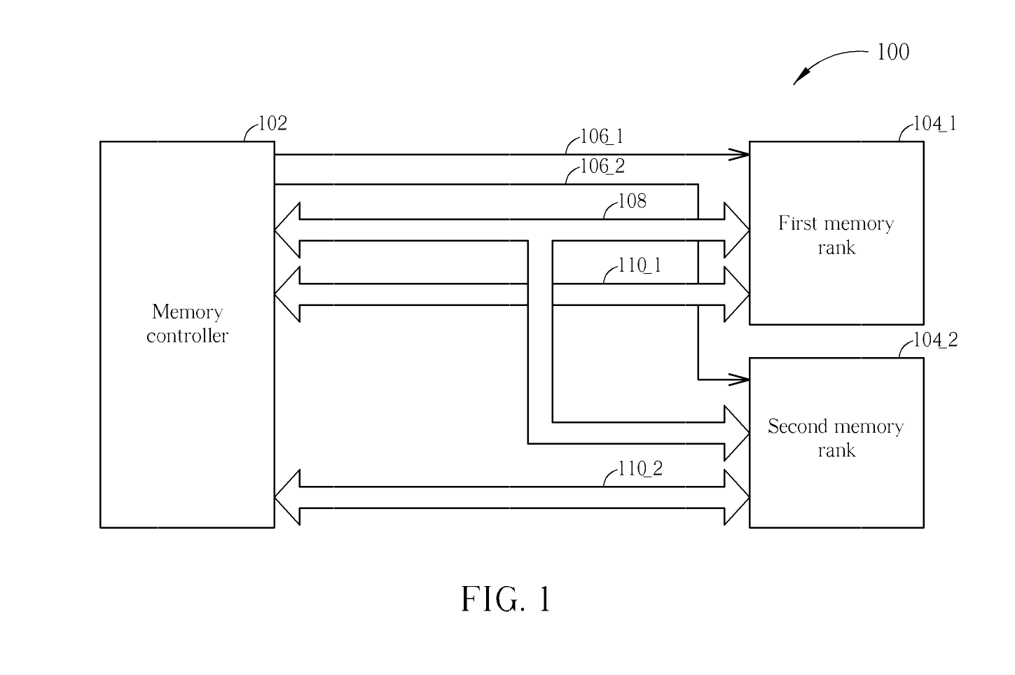

Please refer to FIG. 1, which is a diagram illustrating a data access system according to a first exemplary embodiment of the present invention. The exemplary data access system 100 includes, but is not limited to, a memory controller 102; a plurality of memory ranks including at least a first memory rank 104_1 and a second memory rank 104_2; a plurality of chip select buses including at least a first chip select bus 106_1 coupled between the memory controller 102 and the first memory rank 104_1 and a second chip select bus 106_2 coupled between the memory controller 102 and the second memory rank 104_2; a group of shared buses 108 shared by the first and second memory ranks 104_1, 104_2 and coupled between the memory controller 102 and each of the first and second memory ranks 104_1, 104_2; a first group of dedicated buses 110_1 dedicated to the first memory rank 104_1 and coupled between the memory controller 102 and the first memory rank 104_1; and a second group of dedicated buses 110_2 dedicated to the second memory rank 104_2 and coupled between the memory controller 102 and the second memory rank 104_2. Each of the first memory rank 104_1 and the second memory rank 104_2 may have one or more memory devices, such as DRAM devices, included therein. It should be noted that only two memory ranks are shown in FIG. 1 for illustrative purposes. However, the number of implemented memory ranks may be adjusted according to actual design requirement. Please note that, in accordance with the design rules of the exemplary data access system 100 proposed in the present invention, the number of implemented chip select buses and the number of implemented groups of dedicated buses should be adjusted correspondingly when the number of implemented memory ranks is adjusted.

In one exemplary implementation, the group of shared buses 108 may include a plurality of address buses used for transmitting memory addresses (e.g., A[14:0]) and/or bank addresses (e.g., BA[2:0]). In another exemplary implementation, the group of shared buses 108 may include a plurality of command buses used for transmitting command(s) such as a clock enable (CKE) signal, an on die termination (ODT) signal, a reset (RESET) signal, a row address strobe (RAS) signal, a column address strobe (CAS) signal, and/or a write enable (WE) signal. In yet another exemplary implementation, the group of shared buses 108 may include all of the aforementioned address buses and command buses.

In one exemplary implementation, each of the first group of dedicated buses 110_1 and the second group of dedicated buses 110_2 may include a plurality of data buses for transmitting data to be written into the corresponding memory rank or transmitting data read from the corresponding memory rank. For example, the first group of dedicated buses 110_1 may include data buses DQ[8×N−1:0], and the second group of dedicated buses 110_2 may include data buses DQ[8×2N×1:8×N]. In another exemplary implementation, each of the first group of dedicated buses 110_1 and the second group of dedicated buses 110_2 may include a plurality of data mask buses for transmitting input/output mask (DQM) signals which are used to suppress data input/output when asserted. For example, the first group of dedicated buses 110_1 may include data mask buses DQM[N−1:0], and the second group of dedicated buses 110_2 may include data mask buses DQM[2N−1:N]. In another exemplary implementation, each of the first group of dedicated buses 110_1 and the second group of dedicated buses 110_2 may include a plurality of data strobe buses used for transmitting data strobe (DQS) signals. For example, the first group of dedicated buses 110_1 may include differential data strobe buses DQSP[N−1:0] and DQSN[N−1:0], and the second group of dedicated buses 110_2 may include differential data strobe buses DQSP[2N−1:N] and DQSN[2N−1:N]. In yet another exemplary implementation, each of the first group of dedicated buses 110_1 and the second group of dedicated buses 110_2 may include all of the aforementioned data buses, data mask buses, and data strobe buses.

The exemplary data access system 100 shown in FIG. 1 may support a plurality of different operational modes. Further description is detailed as follows.

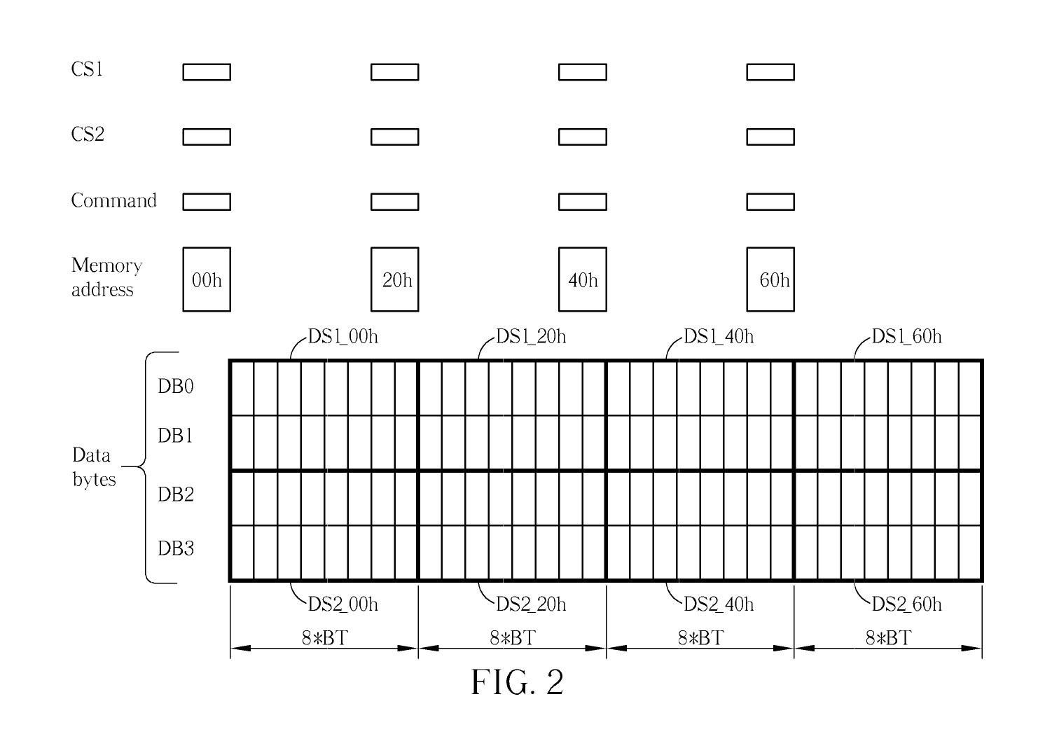

Please refer to FIG. 2, which is a timing diagram illustrating the exemplary data access system 100 operating under a first operational mode. Suppose that the first chip select bus 106_1 is used for transmitting a first chip select signal CS1, the second chip select bus 106_2 is used for transmitting a second chip select signal CS2, the group of shared buses 108 is used for transmit commands and memory addresses, each of the first memory rank 104_1 and the second memory rank 104_2 has a two-byte data width, the first group of dedicated buses 110_1 is used for transmitting two data bytes DB0 and DB1 to be written into the first memory rank 104_1 or read from the first memory rank 104_1 during each bit-time BT of the data bus, the second group of dedicated buses 110_2 is used for transmitting two data bytes DB2 and DB3 to be written into the second memory rank 104_2 or read from the second memory rank 104_2 during each bit-time BT of the data bus, and the burst length is equal to 8×BT. As shown in FIG. 2, the memory controller 102 accesses (reads/writes) the first and second memory ranks 104_1, 104_2 for a first data DS1_00h and a second data DS2_00h respectively transmitted through the first group of dedicated buses 110_1 and the second group of dedicated buses 110_2 by simultaneously asserting the first chip select signal CS1 and the second chip select signal CS2 respectively transmitted to the first and second memory ranks 104_1, 104_2 through the first and second chip select buses 106_1, 106_2, simultaneously generating a command to the first and second memory ranks 104_1, 104_2 through the group of shared buses 108, and simultaneously generating a memory address 00h to the first and second memory ranks 104_1, 104_2 through the group of shared buses 108. Similarly, the following first data DS1_20h/DS1_40h/DS1_60h and second data DS2_20h/DS2_40h/DS2_60h addressed by the memory address 20h/40h/60h are accessed according to a burst length equal to 8×BT. In this exemplary embodiment, each of the accessed first data and second data has 16 bytes. Thus, the total size of data accessed in response to one read/write request is 32-byte.

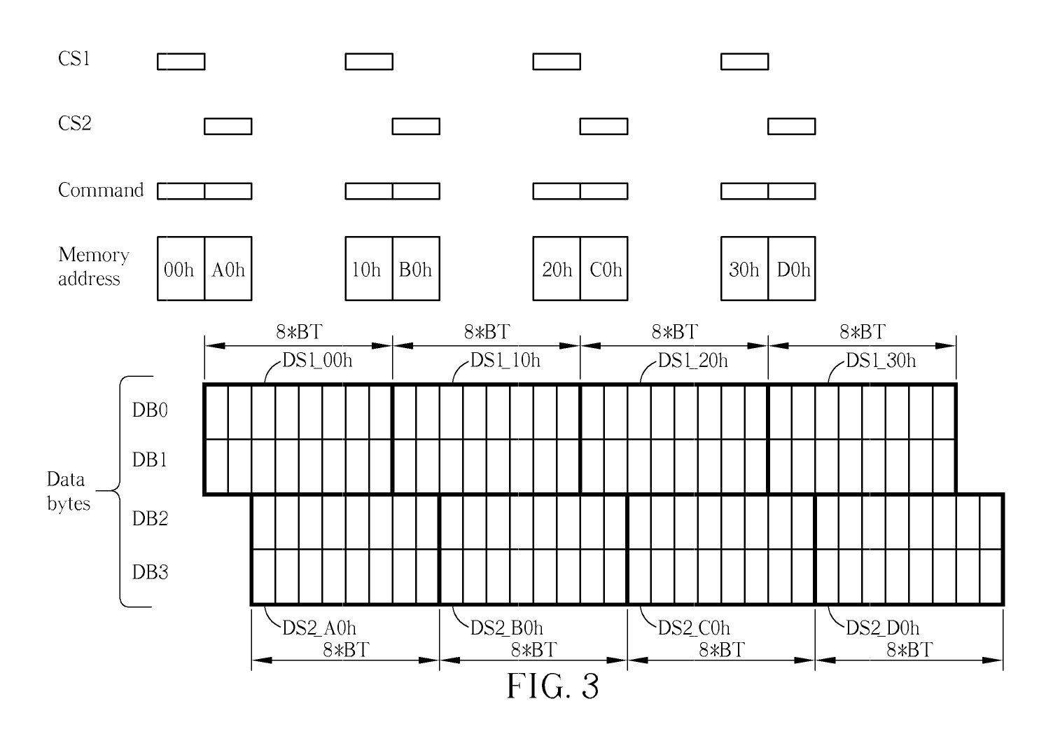

Please refer to FIG. 3, which is a timing diagram illustrating the exemplary data access system 100 operating under a second operational mode. As shown in FIG. 3, the memory controller 102 accesses (reads/writes) the first and second memory ranks 104_1, 104_2 for a first data DS1_00h and a second data DS2_A0h respectively transmitted through the first group of dedicated buses 110_1 and the second group of dedicated buses 110_2 by successively asserting the first chip select signal CS1 and the second chip select signal CS2 respectively transmitted to the first and second memory ranks 104_1, 104_2 through the first and second chip select buses 106_1, 106_2, successively generating a first command and a second command to the first and second memory ranks 104_1, 104_2 through the group of shared buses 108 (it should be noted that the first command delivered to the second memory rank 104_2 has no effect on the second memory rank 104_2 when the second chip select signal CS2 is not asserted yet, and the second command delivered to the first memory rank 104_1 has no effect on the first memory rank 104_1 when the first chip select signal CS1 is deasserted), and successively generating a first memory address 00h and a second memory address A0h to the first and second memory ranks 104_1, 104_2 through the group of shared buses 108 (it should be noted that the first memory address 00h delivered to the second memory rank 104_2 has no effect on the second memory rank 104_2 when the second chip select signal CS2 is not asserted yet, and the second memory address A0h delivered to the first memory rank 104_1 has no effect on the first memory rank 104_1 when the first chip select signal CS1 is deasserted). Similarly, the following first data DS1_10h/DS1_20h/DS1_30h addressed by the memory address 10h/20h/30h and second data DS2_B0h/DS2_C0h/DS2_D0h addressed by the memory address B0h/C0h/D0h are accessed according to a burst length equal to 8×BT. In this exemplary embodiment, each of the accessed first data and second data has 16 bytes. It should be noted that the total size of data accessed in response to one read/write request is 16-byte rather than 32-byte due to the fact that the first chip select signal CS1 and the second chip select signal CS2 are not asserted at the same time.

Regarding the exemplary data access system 100 operating under the first operational mode, some of the desired data (e.g., DS2_A0h/DS2_B0h/DS2_C0h/DS2_D0h) will be accessed after the data access of certain data (e.g., DS1_00h/DS1_20h/DS1_40h/DS1_60h) has been accomplished. However, regarding the exemplary data access system 100 operating under the second operational mode, it is capable of accessing some of the desired data (e.g., DS2_A0h/DS2_B0h/DS2_C0h/DS2_D0h) earlier. Therefore, the overall system performance may be improved greatly.

As shown in FIG. 3, the first memory rank 104_1 will be sequentially accessed for the first data DS1_00h, DS1_10h, DS1_20h and DS1_30h that are successively addressed by sequential memory addresses 00h, 10h, 20h, and 30h, and the second memory rank 104_2 will be sequentially accessed for the second data DS2_A0h, DS2_B0h, DS2_C0h and DS2_D0h that are successively addressed by sequential memory addresses A0h, B0h, C0h, and D0h. In other words, each of the first memory rank 104_1 and the second memory rank 104_2 is sequentially accessed due to a plurality of consecutive memory addresses. However, this is for illustrative purposes only, and is not meant to be a limitation of the present invention. In an alternative design, the data access of the first and second memory ranks 104_1 and 104_2 may be performed in an interleaving manner.

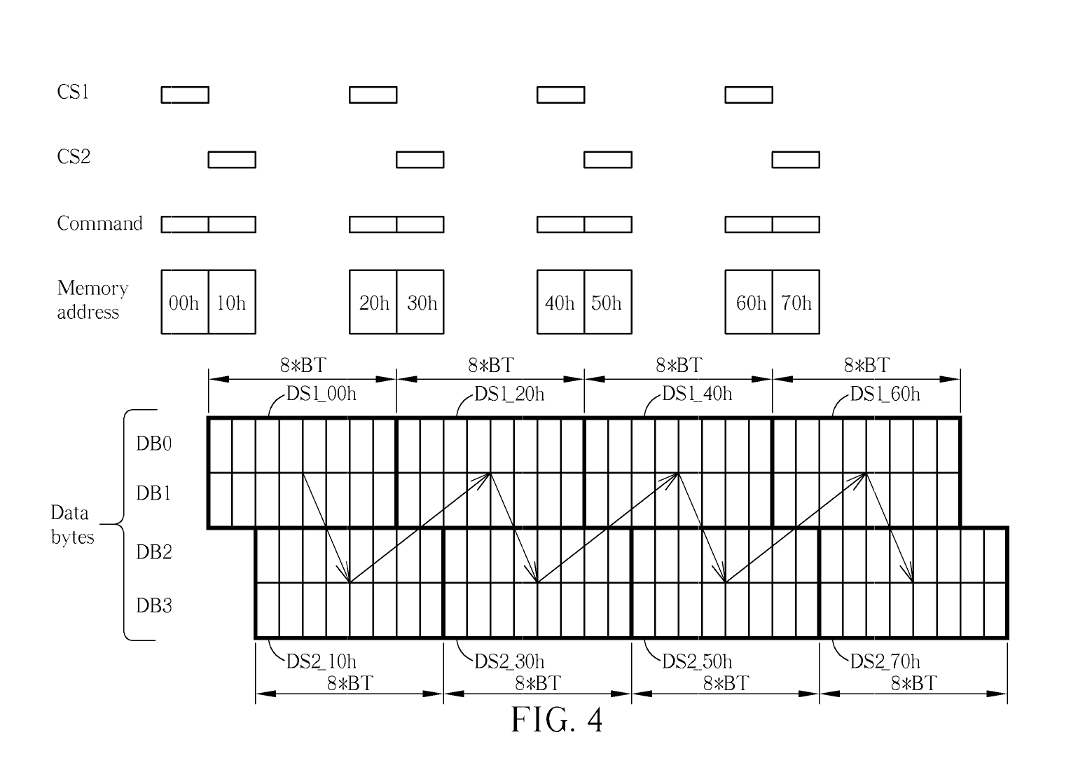

Please refer to FIG. 4, which is a timing diagram illustrating the exemplary data access system 100 operating under a third operational mode. As shown in FIG. 4, the memory controller 102 accesses (reads/writes) the first and second memory ranks 104_1, 104_2 for a first data DS1_00h and a second data DS2_10h respectively transmitted through the first group of dedicated buses 110_1 and the second group of dedicated buses 110_2 by successively asserting the first chip select signal CS1 and the second chip select signal CS2 respectively transmitted to the first and second memory ranks 104_1, 104_2 through the first and second chip select buses 106_1, 106_2, successively generating a first command and a second command to the first and second memory ranks 104_1, 104_2 through the group of shared buses 108 (it should be noted that the first command delivered to the second memory rank 104_2 has no effect on the second memory rank 104_2 when the second chip select signal CS2 is not asserted yet, and the second command delivered to the first memory rank 104_1 has no effect on the first memory rank 104_1 when the first chip select signal CS1 is deasserted), and successively generating a first memory address 00h and a second memory address 10h to the first and second memory ranks 104_1, 104_2 through the group of shared buses 108 (it should be noted that the first memory address 00h delivered to the second memory rank 104_2 has no effect on the second memory rank 104_2 when the second chip select signal CS2 is not asserted yet, and the second memory address 10h delivered to the first memory rank 104_1 has no effect on the first memory rank 104_1 when the first chip select signal CS1 is deasserted). Similarly, the following first data DS1_20h/DS1_40h/DS1_60h addressed by the memory address 20h/40h/60h and second data DS2_30h/DS2_50h/DS2_70h addressed by the memory address 30h/50h/70h are accessed according to a burst length equal to 8×BT. In this exemplary embodiment, each of the accessed first data and second data has 16 bytes. Besides, the total size of data accessed in response to one read/write request is 16-byte rather than 32-byte. Moreover, when the memory addresses 10h-70h are successively transmitted, the first memory rank 104_1 and the second memory rank 104_4 are accessed in an interleaving manner as indicated by the arrow symbols shown in FIG. 4. As can be seen from FIG. 4, the desired data DS2_10h/DS2_30h/DS2_50h/DS2_70h may be accessed earlier. Though the access latency may be slightly increased due to the interleaved data access, the overall system performance may still benefit greatly by such a memory system implementation.

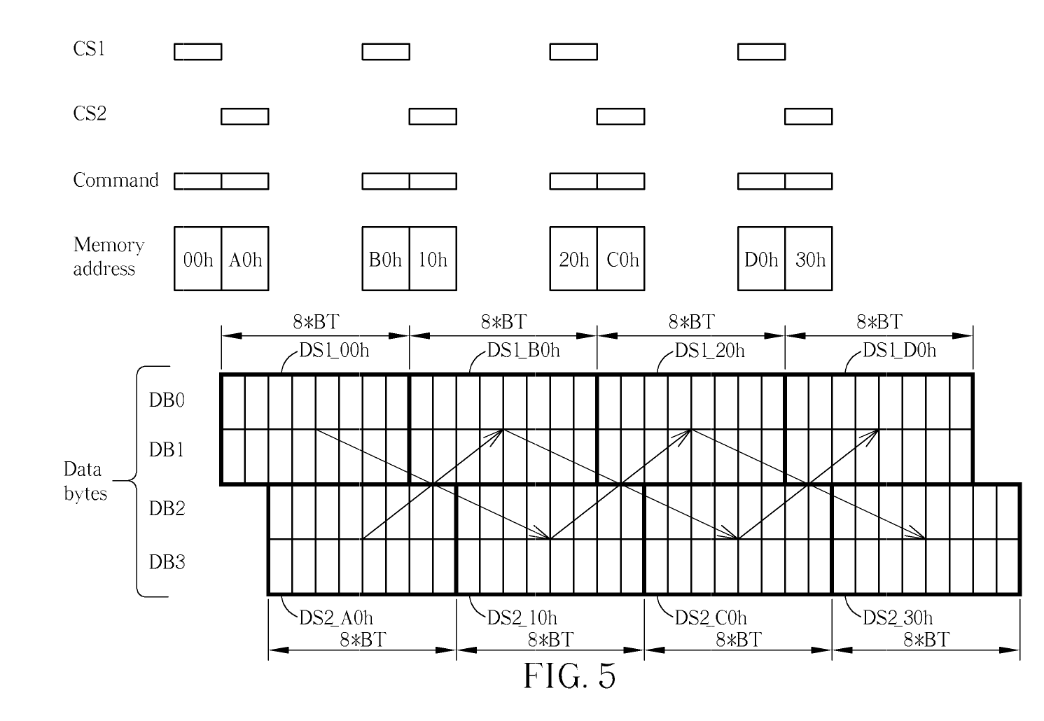

In the example shown in FIG. 4, the first data DS1_00h/DS1_20h/DS1_40h/DS1_60h and the second data DS2_10h/DS2_30h/DS2_50h/DS2_70h are accessed in response to a single thread (e.g., a single agent) which requests data addressed by consecutive memory addresses 00h-70h. However, this is for illustrative purposes only, and is not meant to be a limitation of the present invention. Please refer to FIG. 5, which is a timing diagram illustrating the exemplary data access system 100 operating under a fourth operational mode. As shown in FIG. 5, the memory controller 102 accesses (reads/writes) the first and second memory ranks 104_1, 104_2 for a first data DS1_00h and a second data DS2_A0h respectively transmitted through the first group of dedicated buses 110_1 and the second group of dedicated buses 110_2 by successively asserting the first chip select signal CS1 and the second chip select signal CS2 respectively transmitted to the first and second memory ranks 104_1, 104_2 through the first and second chip select buses 106_1, 106_2, successively generating a first command and a second command to the first and second memory ranks 104_1, 104_2 through the group of shared buses 108 (it should be noted that the first command delivered to the second memory rank 104_2 has no effect on the second memory rank 104_2 when the second chip select signal CS2 is not asserted yet, and the second command delivered to the first memory rank 104_1 has no effect on the first memory rank 104_1 when the first chip select signal CS1 is deasserted), and successively generating a first memory address 00h and a second memory address A0h to the first and second memory ranks 104_1, 104_2 through the group of shared buses 108 (it should be noted that the first memory address 00h delivered to the second memory rank 104_2 has no effect on the second memory rank 104_2 when the second chip select signal CS2 is not asserted yet, and the second memory address A0h delivered to the first memory rank 104_1 has no effect on the first memory rank 104_1 when the first chip select signal CS1 is deasserted). Similarly, the following first data DS1_B0h/DS1_20h/DS1_D0h addressed by the memory address B0h/20h/D0h and second data DS2_10h/DS2_C0h/DS2_30h addressed by the memory address 10h/C0h/30h are accessed according to a burst length equal to 8×BT. In this exemplary embodiment, each of the accessed first data and second data has 16 bytes. In addition, the total size of data accessed in response to one read/write request is 16-byte rather than 32-byte. Moreover, the first data DS1_00h/DS1_B0h/DS1_{—}20h/DS1_D0h and the second data DS2_A0h/DS2_10h/DS2_C0h/DS2_30h are accessed in response to different threads (e.g., different agents) including one thread (e.g., one agent) which requests data addressed by consecutive memory addresses 00h-30h and another thread (e.g., another agent) which requests data addressed by consecutive memory addresses A0h-D0h. Regarding data access for each of the different threads, the first memory rank 104_1 and the second memory rank 104_2 are accessed in an interleaving manner as indicated by the arrow symbols shown in FIG. 5.

As mentioned above, when the exemplary data access system 100 is configured to operate under the first operational mode, the total size of data accessed in response to one read/write request is 32-byte. However, it is possible that the maximum bandwidth of the memory rank/memory bus is not utilized. For example, in a case where the agent's requested data length is 16-byte, 50% bandwidth will be wasted. To solve this, the exemplary data access system 100 may be configured to operate under one of the aforementioned second operational mode, third operational mode, and fourth operational mode. As the total size of data accessed in response to one read/write request is 16-byte rather than 32-byte, the amount of wasted bandwidth can be reduced or avoided. Please note that the memory controller 102 should be properly designed for allowing the exemplary data access system 100 to operate under one of the aforementioned second operational mode, third operational mode. For example, the page table may need more storage space and the command scheduling logic may require more complicated circuitry. As a person skilled in the art should readily understand details directed to designs of the page table and the command scheduling logic for the memory controller 102, further description is omitted here for brevity.

Besides, as multiple read/write requests issued from different agents/threads are allowed to be executed on the memory bus at the same time when the exemplary data access system 100 is configured to operate under one of the aforementioned second operational mode, third operational mode, and fourth operational mode, the data access efficiency may be improved greatly.

Please note that the chip select signal is more timing critical than other control signals. Thus, higher loading viewed by one chip select signal would lower the maximum system speed. Regarding the exemplary data access system 100 shown in FIG. 1, one chip select bus 106_1/106_2 is coupled to a single memory rank 104_1/104_2. Therefore, the exemplary data access system 100 is suitable for any high-speed application since the use of the exemplary data access system 100 will not significantly affect the maximum system speed.

In addition to the aforementioned chip select signal, some control signal(s) may be regarded as timing critical signals. For example, higher loading viewed by one ODT/CKE signal may also lower the maximum system speed. Alternative data access systems each having multiple configurable chip select signals and ODT/CKE signals transmitted to different memory ranks are proposed in the present invention. Further details are described as follows.

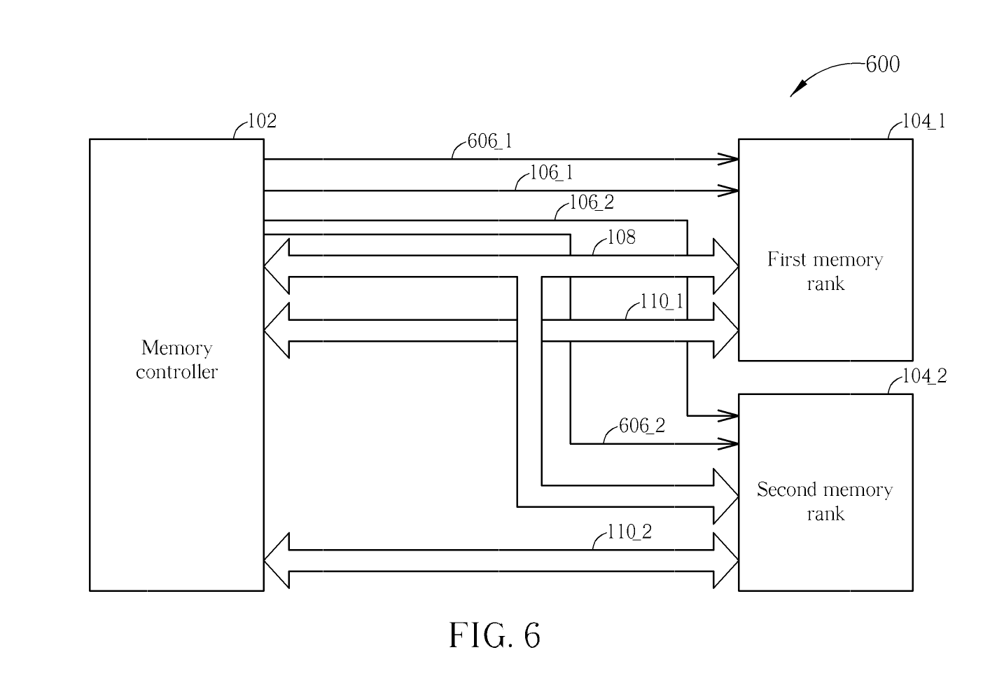

Please refer to FIG. 6, which is a diagram illustrating a data access system according to a second exemplary embodiment of the present invention. The hardware configuration of the exemplary data access system 600 is similar to that of the exemplary data access system 100, and the major difference is that the exemplary data access system 600 further includes a plurality of ODT buses including at least a first ODT bus 606_1 coupled between the memory controller 102 and the first memory rank 104_1 and a second ODT bus 606_2 coupled between the memory controller 102 and the second memory rank 104_2. Please note that, in accordance with the design rules of the exemplary data access system 600 proposed in the present invention, the number of implemented chip select buses, the number of implemented on die termination buses, and the number of implemented groups of dedicated buses should be adjusted correspondingly when the number of implemented memory ranks is adjusted.

In one exemplary implementation of the data access system 600, the group of shared buses 108 may include a plurality of address buses used for transmitting memory addresses and/or bank addresses. In another exemplary implementation of the data access system 600, the group of shared buses 108 may include a plurality of command buses used for transmitting command(s) such as a clock enable (CKE) signal, a reset (RESET) signal, a row address strobe (RAS) signal, a column address strobe (CAS) signal, and/or a write enable (WE) signal. In yet another exemplary implementation of the data access system 600, the group of shared buses 108 may include all of the aforementioned address buses and command buses.

In one exemplary implementation of the data access system 600, each of the first group of dedicated buses 110_1 and the second group of dedicated buses 110_2 may include a plurality of data buses for transmitting data to be written into the corresponding memory rank or transmitting data read from the corresponding memory rank. In another exemplary implementation of the data access system 600, each of the first group of dedicated buses 110_1 and the second group of dedicated buses 110_2 may include a plurality of data mask buses for transmitting input/output mask (DQM) signals which are used to suppress data input/output when asserted. In another exemplary implementation of the data access system 600, each of the first group of dedicated buses 110_1 and the second group of dedicated buses 110_2 may include a plurality of data strobe buses used for transmitting data strobe (DQS) signals. In yet another exemplary implementation of the data access system 600, each of the first group of dedicated buses 110_1 and the second group of dedicated buses 110_2 may include all of the aforementioned data buses, data mask buses, and data strobe buses.

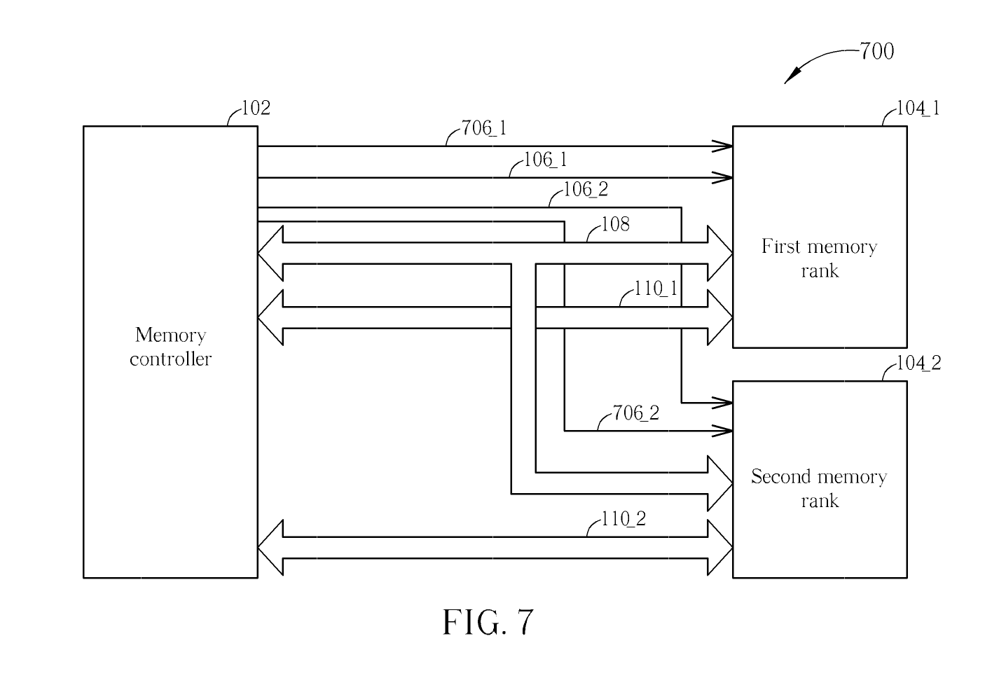

Please refer to FIG. 7, which is a diagram illustrating a data access system according to a third exemplary embodiment of the present invention. The hardware configuration of the exemplary data access system 700 is similar to that of the exemplary data access system 100, and the major difference is that the exemplary data access system 700 further includes a plurality of CKE buses including at least a first CKE bus 706_1 coupled between the memory controller 102 and the first memory rank 104_1 and a second CKE bus 706_2 coupled between the memory controller 102 and the second memory rank 104_2. Please note that, in accordance with the design rules of the exemplary data access system 700 proposed in the present invention, the number of implemented chip select buses, the number of implemented clock enable buses, and the number of implemented groups of dedicated buses should be adjusted correspondingly when the number of implemented memory ranks is adjusted.

In one exemplary implementation of the data access system 700, the group of shared buses 108 may include a plurality of address buses used for transmitting memory addresses and/or bank addresses. In another exemplary implementation of the data access system 700, the group of shared buses 108 may include a plurality of command buses used for transmitting command(s) such as an on die termination (ODT) signal, a reset (RESET) signal, a row address strobe (RAS) signal, a column address strobe (CAS) signal, and/or a write enable (WE) signal. In yet another exemplary implementation of the data access system 700, the group of shared buses 108 may include all of the aforementioned address buses and command buses.

In one exemplary implementation of the data access system 700, each of the first group of dedicated buses 110_1 and the second group of dedicated buses 110_2 may include a plurality of data buses for transmitting data to be written into the corresponding memory rank or transmitting data read from the corresponding memory rank. In another exemplary implementation of the data access system 700, each of the first group of dedicated buses 110_1 and the second group of dedicated buses 110_2 may include a plurality of data mask buses for transmitting input/output mask (DQM) signals which are used to suppress data input/output when asserted. In another exemplary implementation of the data access system 700, each of the first group of dedicated buses 110_1 and the second group of dedicated buses 110_2 may include a plurality of data strobe buses used for transmitting data strobe (DQS) signals. In yet another exemplary implementation of the data access system 700, each of the first group of dedicated buses 110_1 and the second group of dedicated buses 110_2 may include all of the aforementioned data buses, data mask buses, and data strobe buses.

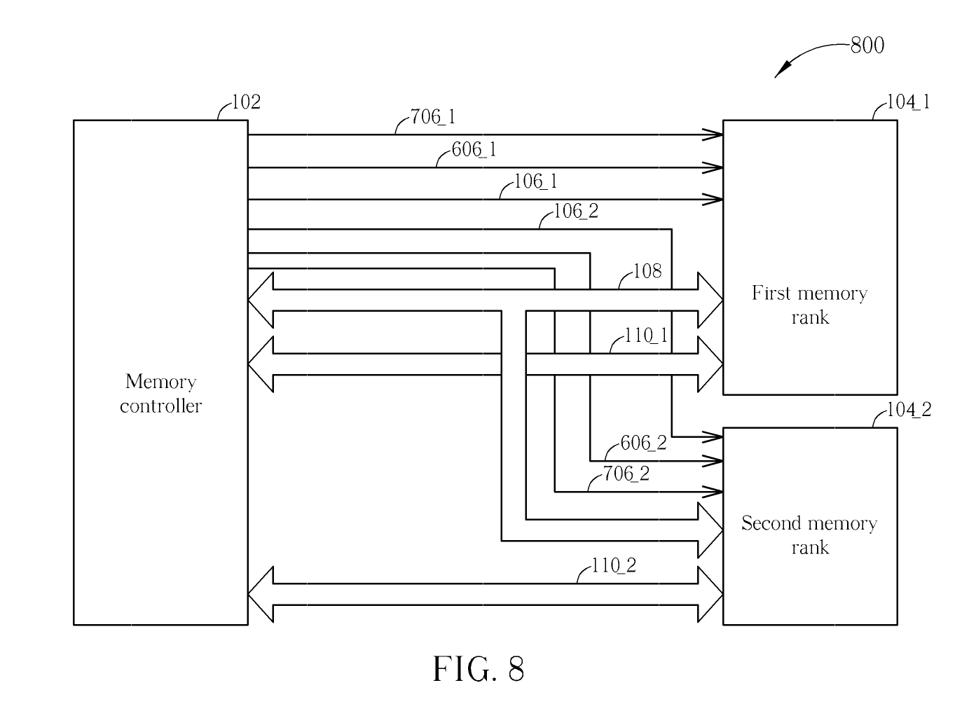

Please refer to FIG. 8, which is a diagram illustrating a data access system according to a fourth exemplary embodiment of the present invention. As the chip select signal, the on die termination signal, and the clock enable signal are timing critical, the data access system 800 is configured to have dedicated chip select buses (e.g., 106_1 and 106_2), ODT buses (e.g., 606_1 and 606_2), and CKE buses (e.g., 706_1 and 706_2) included therein for achieving optimum system performance. As a person skilled in the art can readily understand possible implementations of the group of shared buses 108, the first group of dedicated buses 110_1, and the second group of dedicated buses 110_2 of the data access system 800 after reading above paragraphs directed to the data access systems 600 and 700, further description is omitted here for brevity.

Please note that the exemplary data access systems 600, 700, and 800 may also support a plurality of different operational modes as mentioned above. For example, each of the exemplary data access systems 600, 700, and 800 may have the same memory access operation shown in FIG. 3, FIG. 4, or FIG. 5. Regarding the data access system 100 operating in one of the supported operational modes, the same ODT/CKE bus is shared between the first memory rank 104_1 and the second memory rank 104_2. It should be noted that the first ODT/CKE command delivered to the second memory rank 104_2 has no effect on the second memory rank 104_2 when the second chip select signal CS2 is not asserted, and the second ODT/CKE command delivered to the first memory rank 104_1 has no effect on the first memory rank 104_1 when the first chip select signal CS1 is not asserted. To put it simply, an ODT/CKE command can be asserted as long as one of a plurality of memory devices needs it, and the extra cycle to other memory devices is harmless.

Regarding the data access system 600/800 operating in one of the supported operational modes, one dedicated ODT bus is assigned to the first memory rank 104_1 and another dedicated ODT bus is assigned to the second memory rank 104_2 for controlling the first and second memory ranks 104_1, 104_2, respectively. Regarding the data access system 700/800 operating in one of the supported operational modes, one dedicated CKE bus is assigned to the first memory rank 104_1 and another dedicated CKE bus is assigned to the second memory rank 104_2 for controlling the first and second memory ranks 104_1, 104_2, respectively. Therefore, the first memory rank 104_1 is accessed through the first chip select bus 106_1, the first ODT/CKE bus 606_1/706_1, the group of shared buses 108, and the first group of dedicated buses 110_1, and the second memory rank 104_2 is accessed through the second chip select bus 106_2, the second ODT/CKE bus 606_2/706_2, the group of shared buses 108, and the second group of dedicated buses 110_2.

Those skilled in the art will readily observe that numerous modifications and alterations of the device and method may be made while retaining the teachings of the invention.

What is claimed is:

1. A data access system, comprising:
a memory controller;
a plurality of memory ranks, including at least a first memory rank and a second memory rank;
a plurality of chip select buses, including at least a first chip select bus coupled between the memory controller and the first memory rank, and a second chip select bus coupled between the memory controller and the second memory rank;
a group of shared buses, shared by the first and second memory ranks and coupled between the memory controller and each of the first and second memory ranks;
a first group of dedicated buses, dedicated to the first memory rank and coupled between the memory controller and the first memory rank; and
a second group of dedicated buses, dedicated to the second memory rank and coupled between the memory controller and the second memory rank.

2. The data access system of claim 1, wherein the group of shared buses includes a plurality of address buses.

3. The data access system of claim 1, wherein the group of shared buses includes a plurality of command buses.

4. The data access system of claim 1, wherein each of the first group of dedicated buses and the second group of dedicated buses includes a plurality of data buses.

5. The data access system of claim 1, wherein each of the first group of dedicated buses and the second group of dedicated buses includes a plurality of data mask buses.

6. The data access system of claim 1, wherein each of the first group of dedicated buses and the second group of dedicated buses includes a plurality of data strobe buses.

7. The data access system of claim 1, wherein the memory controller accesses the first and second memory ranks for a first data and a second data respectively transmitted through the first group of dedicated buses and the second group of dedicated buses by simultaneously asserting a first chip select signal and a second chip select signal respectively transmitted to the first and second memory ranks through the first and second chip select buses, simultaneously generating a command to the first and second memory ranks through the group of shared buses, and simultaneously generating a memory address to the first and second memory ranks through the group of shared buses.

8. The data access system of claim 1, wherein the memory controller accesses the first and second memory ranks for a first data and a second data respectively transmitted through the first group of dedicated buses and the second group of dedicated buses by successively asserting a first chip select signal and a second chip select signal respectively transmitted to the first and second memory ranks through the first and second chip select buses, successively generating a first command and a second command to the first and second memory ranks through the group of shared buses, and successively generating a first memory address and a second memory address to the first and second memory ranks through the group of shared buses.

9. The data access system of claim 8, wherein a time period of transmitting the first data through the first group of dedicated buses is overlapped with a time period of transmitting the second data through the second group of dedicated buses.

10. The data access system of claim 8, wherein the first data and the second data are accessed in response to a single thread.

11. The data access system of claim 10, wherein regarding data access for the single thread, the first memory rank and the second memory rank are accessed in an interleaving manner.

12. The data access system of claim 8, wherein the first data and the second data are accessed in response to different threads, respectively.

13. The data access system of claim 12, wherein regarding data access for each of the different threads, the first memory rank and the second memory rank are accessed in an interleaving manner.

14. The data access system of claim 1, further comprising:
a plurality of on die termination (ODT) buses, including at least a first ODT bus coupled between the memory controller and the first memory rank, and a second ODT bus coupled between the memory controller and the second memory rank.

15. The data access system of claim 1, further comprising:
a plurality of clock enable (CKE) buses, including at least a first CKE bus coupled between the memory controller and the first memory rank, and a second CKE bus coupled between the memory controller and the second memory rank.

16. A data access method, comprising:
coupling a first chip select bus to a first memory rank;
coupling a second chip select bus to a second memory rank;
sharing a group of shared buses by the first and second memory ranks;
utilizing a first group of dedicated buses dedicated to the first memory rank;
utilizing a second group of dedicated buses dedicated to the second memory rank;
accessing the first memory rank through at least the first chip select bus, the group of shared buses, and the first group of dedicated buses; and
accessing the second memory rank through at least the second chip select bus, the group of shared buses, and the second group of dedicated buses.

17. The data access method of claim 16, wherein the group of shared buses includes a plurality of address buses.

18. The data access method of claim 16, wherein the group of shared buses includes a plurality of command buses.

19. The data access method of claim 16, wherein each of the first group of dedicated buses and the second group of dedicated buses includes a plurality of data buses.

20. The data access method of claim 16, wherein each of the first group of dedicated buses and the second group of dedicated buses includes a plurality of data mask buses.

21. The data access method of claim 16, wherein each of the first group of dedicated buses and the second group of dedicated buses includes a plurality of data strobe buses.

22. The data access method of claim 16, wherein the steps of accessing the first memory ranks and accessing the second memory rank comprise:
simultaneously asserting a first chip select signal and a second chip select signal respectively transmitted to the first and second memory ranks through the first and second chip select buses;
simultaneously generating a command to the first and second memory ranks through the group of shared buses; and
simultaneously generating a memory address to the first and second memory ranks through the group of shared buses.

23. The data access method of claim 16, wherein the steps of accessing the first memory ranks and accessing the second memory rank comprise:
accessing the first and second memory ranks for a first data and a second data respectively transmitted through the first group of dedicated buses and the second group of dedicated buses by:
successively asserting a first chip select signal and a second chip select signal respectively transmitted to the first and second memory ranks through the first and second chip select buses;
successively generating a first command and a second command to the first and second memory ranks through the group of shared buses; and
successively generating a first memory address and a second memory address to the first and second memory ranks through the group of shared buses.

24. The data access method of claim 23, wherein a time period of transmitting the first data through the first group of dedicated buses is overlapped with a time period of transmitting the second data through the second group of dedicated buses.

25. The data access method of claim 23, wherein the first data and the second data are accessed in response to a single thread.

26. The data access method of claim 25, wherein regarding data access for the single thread, the first memory rank and the second memory rank are accessed in an interleaving manner.

27. The data access method of claim 23, wherein the first data and the second data are accessed in response to different threads, respectively.

28. The data access method of claim 27, wherein regarding data access for each of the different threads, the first memory rank and the second memory rank are accessed in an interleaving manner.

29. The data access method of claim 16, further comprising:
coupling a first on die termination (ODT) bus to the first memory rank; and
coupling a second ODT bus to the second memory rank;
wherein the step of accessing the first memory rank comprises: accessing the first memory rank through the first chip select bus, the first ODT bus, the group of shared buses, and the first group of dedicated buses; and the step of accessing the second memory rank comprises: accessing the second memory rank through the second chip select bus, the second ODT bus, the group of shared buses, and the second group of dedicated buses.

30. The data access method of claim 16, further comprising:
coupling a first clock enable (CKE) bus to the first memory rank; and
coupling a second CKE bus to the second memory rank;
wherein the step of accessing the first memory rank comprises: accessing the first memory rank through the first chip select bus, the first CKE bus, the group of shared buses, and the first group of dedicated buses; and the step of accessing the second memory rank comprises: accessing the second memory rank through the second chip select bus, the second CKE bus, the group of shared buses, and the second group of dedicated buses.
